(19) United States
(12) Patent Application Publication
(10) Pub. No.: US 2002/0052428 A1
(43) Pub. Date: May 2, 2002

(54) Ultraviolet-curing composition

(75) Inventor: Yoshihide Arai, Tokyo (JP)

Correspondence Address: SUGHRUE MION, PLLC, 2100 Pennsylvania Avenue, NW, Washington, DC, 20037-3213, US

(73) Assignee: THREE BOND CO., LTD.

(21) Appl. No.: 10/032,448

(22) Filed: Jan. 2, 2002

Related U.S. Application Data
(63) Continuation of application No. 09/647,614, filed on Dec. 5, 2000.

(30) Foreign Application Priority Data
Apr. 3, 1998 (JP) P. HEI. 10-091080

(51) Int. Cl. C08G 2/00; C08F 2/46

(52) U.S. Cl. 522/33; 522/47

(57) ABSTRACT

When dust or contaminants invade into a hard disk drive and adhere to the surface of a magnetic head, there arise operation errors in recording and reading out signals. Accordingly, it has been required to develop compositions containing little outgas components as ultraviolet-curing resins to be used in assembling hard disk drives.

Means for Solution:

As urethane (meth)acrylate in an ultraviolet-curing composition, use is made of a product obtained by an addition reaction between a polyisocyanate compound, which is produced by reacting a polyether or a polyester having a hydroxy group with a diisocyanate group, with a hydroxyalkyl (meth)acrylate. In the addition reactions, an organic zinc or an amine compound is used as a catalyst so as to give a composition free from organotin compounds.

### TECHNICAL FIELD

This invention relates to ultraviolet-curing resin compositions which are suitable for assembling hard disk drives.

### BACKGROUND ART

In assembling hard disk drives and parts thereof, it has been a practice to use ultraviolet-curing resins in fixing and bonding various parts so as to satisfy requests for shortening the period of time for the assembly or manufacture and for avoiding any heating treatment. For example, JP-A-2-50378 (the term “JP-A” as used herein means an “unexamined published Japanese patent application”) discloses sealing a housing case with an ultraviolet-curing resin.

When dust or contaminants invade into a hard disk drive and adhere to the surface of a magnetic head, there arise operation errors in recording and reading out signals. For example, JP-A-6-105502, JP-A-8-72189 and JP-A-8-74863, each relating to motors for HDDs, point out that grease and dust scattered by motors cause operation errors. Accordingly, it has been similarly required to develop compositions, which suffer from little formation of contaminants or outgas, as ultraviolet-curing resins to be used in assembling hard disk drives. To satisfy this requirement, there have been employed acrylate compounds of high-molecular weight oligomers as the components constituting ultraviolet-curing resins so as to minimize the outgas components.

### DISCLOSURE OF THE INVENTION

With the recent tendency toward hard disk drives with enlarged memory capacity and elevated accuracy, the adhesion of outgas components, even at such a low level that has never been considered as causing any operation error hitherto, would bring about operation errors in the case of these hard disk drives with large memory capacity. Even in case of using, for example, an ultraviolet-curing resin containing a high-molecular weight urethane acrylate oligomer as the main component and having removed highly volatile low-molecular weight acrylic monomers, operation errors arise due to the adhesion of outgas components to a disk. Thus, the outgas components adhering to the disk were analyzed and it was consequently found out that organotin compounds employed mainly in the synthesis of the urethane oligomer are contained therein. It was also clarified that these organotin compounds are liable to adhere to the disk surface and form a hard deposit, as compared to other outgas components. As a result, the organotin compounds adhering to the disk under rotation collide with the magnetic head and thus cause operation errors. Moreover, there is a possibility that the organotin compounds, which are highly reactive, might chemically react with metals deposited on the disk thereby causing magnetic data destruction.

Since a disk in a hard disk drive rotates at a high speed, it is preferable to bond and fix the parts to each other by using a rubbery elastomer capable of absorbing the vibration in association with the rotational movement. As the ultraviolet-curing resin to be used in the bonding and fixation, it is therefore appropriate to use those containing, as the main component, urethane acrylate compounds capable of forming flexible cured products. However, urethane acrylate compounds usually contain organotin compounds, and hence the problem of outgas as described above remains.

The inventors paid attention to the fact that operation errors of hard disk drives are caused by organotin compounds, among harmful outgas components, evolved from urethane acrylate compounds. Thus, the invention provides ultraviolet-curing resins containing urethane (meth)acrylate as a main component which contain neither outgas components, having been pointed out as causing troubles, nor organotin compounds, can give a highly flexible cured product, have a small compression set, and are excellent in damping properties, thereby being suitable for assembling hard disk drives.

The invention, which aims at solving the above problem, is characterized in that the curable component of an ultraviolet-curing composition for assembling a hard disk drive is a urethane (meth)acrylate obtained by an addition reaction, using an organic zinc or an amine compound as a catalyst, between:

an isocyanate group of an isocyanate oligomer, which is prepared by using an organic zinc or an amine compound as a catalyst in an addition reaction between an isocyanate group and an active hydrogen; and

a hydroxy group of a hydroxyalkyl (meth)acrylate.

More particularly, the ultraviolet-curing composition for assembling hard disk drives of the invention is characterized in that the above-described urethane (meth)acrylate is a product of an addition reaction, using an organic zinc or an amine compound as a catalyst, between:

an isocyanate group of an isocyanate oligomer, which is prepared, by an addition reaction using an organic zinc or an amine compound, from a polyether having a hydroxy group at a terminal thereof and an isocyanate compound having two or more isocyanate groups per molecule; and

a hydroxy group of a hydroxyalkyl (meth)acrylate, wherein no tin compound is used as a catalyst in these two addition reactions.

Alternatively, the ultraviolet-curing composition for assembling hard disk drives of the invention is characterized in that said polyurethane (meth)acrylate, which is the above-described curable component of said ultraviolet-curing composition, is a product of an addition reaction, using an organic zinc or an amine compound as a catalyst, between:

an isocyanate group of an isocyanate oligomer, which is prepared by an addition reaction using an organic zinc or an amine compound between a polyester having a hydroxy group at a terminal or in a side chain thereof and an isocyanate compound having two or more isocyanate groups per molecule; and

a hydroxy group of a hydroxyalkyl (meth)acrylate,

wherein no tin compound is used as a catalyst in these two addition reactions.

Alternatively, the ultraviolet-curing composition for assembling hard disk drives of the invention is characterized in that said polyurethane (meth)acrylate, which is the above-described curable component of said ultraviolet-curing composition, is a product of an addition reaction, using an organic zinc or an amine compound as a catalyst, between:

an isocyanate group of a polyether/polyester copolymerized isocyanate oligomer compound, which is prepared by an addition reaction using an organic zinc or an amine compound among a polyester having a hydroxy group at a terminal or in a side chain thereof, a polyether having a hydroxy group at a terminal thereof, and a diisocyanate compound having two or more isocyanate groups per molecule; and

a hydroxy group of a hydroxyalkyl (meth)acrylate,

wherein no tin compound is used as a catalyst in these two addition reactions.

The above-described polyurethane (meth)acrylate also involves a product formed by subjecting polyester or polyether and at least equimolar amount (to the hydroxy group of the polyester or polyether) of isocyanate compound to a multi-stage addition reaction with the use of either an organic zinc compound or an amine compound to thereby prepare a polyisocyanate oligomer having plural urethane bonds per molecule, and then further performing an addition reaction between the isocyanate group of the polyisocyanate with a hydroxyalkyl (meth)acrylate with the use of either an organic zinc compound or an amine compound, wherein no tin compound is used in all of these addition reactions.

The above-described hydroxyalkyl (meth)acrylate means an acrylic acid ester or a methacrylic acid ester having at least one hydroxy group in the alkoxy group of the ester. Specific examples thereof include 2-hydroxyethyl acrylate, 2-hydroxyethyl methacrylate, 2-hydroxypropyl acrylate, 2-hydroxypropyl methacrylate, pentaerythritol triacrylate, glycerol acrylate, β-hydroxyalkyl (meth)acrylates obtained by reacting (meth)acrylic acid with epoxy compounds and the like.

The polyether having a hydroxy group at a terminal thereof or the polyester having a hydroxy group is selected from among those having a molecular weight of from about 200 to 5,000, preferably from about 400 to 1,000. The polyester having a hydroxy group is industrially produced by adding a polybasic acid to a glycidyl compound.

Examples of the isocyanate compound having two or more isocyanate groups per molecule to be used in preparing the polyisocyanate oligomer include tolylene diisocyanate, diphenylmethane diisocyanate, phenylene diisocyanate, hexamethylene diisocyanate, isophorone diisocyanate, xylylene diisocyanate, naphthalene diisocyanate, lysine diisocyanate and the like.

In the invention, either an organic zinc or an amine compound should be used as a reaction catalyst in the addition reaction between the polyether or polyester having a hydroxy group and the isocyanate compound and in the addition reaction between the polyisocyanate oligomer (i.e., the reaction product obtained by the former addition reaction) and hydroxyalkyl (meth)acrylate.

In the synthesis of urethane compounds, use has been generally made of organotin compounds represented by dibutyltin dilaurate, dibutyltin acetate, etc. or inorganic tin compounds such as stannic chloride, each having an extremely high relative reaction speed and an excellent catalytic effect. When the urethane acrylate compounds peppered by using these organotin compounds are used in the assembly of hard disk drives, it is feared that the tin compounds remaining in the urethane acrylate compounds might adhere as outgas components to the disks or undergo chemical reactions with deposited films of the disks. Therefore, the urethane acrylate compounds prepared by the addition reaction with the use of the tin compounds cannot be employed.

Examples of the organic zinc to be used as a reaction catalyst in the invention include zinc carboxylates such as zinc octylate, zinc octenate, zinc 2-ethylcaproate and the lkie. Examples of the amine compounds include triethylamine, dimethylcyclohexylamine, tetramethylethylenediamine, pentamethyldiethylenetriamine, pentamethyldipropylenetriamine, tetramethylguanidine, triethylenediamine, N-methylmorpholine, 1,2-dimethylimidazole, dimethylaminoethanol, dimethylaminoethoxyethanol, trimethylaminoethylethanolamine, (2-hydroxyethyl)morpholine etheramine, N-methylpiperazine, N,N′-dimethylpiperazine, N-endoethylenepiperazine and the like.

To impart UV-curing properties, photosensitizers (e.g., benzoin ethyl ether, benzoin isobutyl ether, benzophenone, hydroxybenzophenone, methyl benzoylbenzoate, benzyldimethyl ketal, diethyl thioxanthone, diisopropyl thioxanthone, 1-phenyl-2-hydroxy-2-methylpropan-1-one, 1-hydroxycyclohexyl-phenyl ketone, benzil, camphorquinone, phenanthrenequinone, Michler's ketone, trimethylbenzoyldiphenylphosphine oxide and the like) are added to the urethane acrylates obtained by the above-described reaction to give ultraviolet-curing compositions.

### BEST MODE FOR CARRYING OUT THE INVENTION

### EXAMPLE 1

To 50.05 g of diphenylmethane diisocyanate (MDI) employed as an isocyanate compound was added 36 g of a polyether having a hydroxy group at a terminal thereof wherein polypropylene ether had been added to bisphenol A (product name: ADEKA POLYETHER BPX-11, manufactured by Asahi Denka Kogyo K. K.) in the presence of 1.0 g of zinc octylate employed as a reaction catalyst, and the addition reaction was performed at 60 to 80° C. to give a polyisocyanate oligomer having an isocyanate group at a terminal thereof. Next, 100 g of hydroxyethyl acrylate in the equimolar amount or more to the isocyanate group of this polyisocyanate oligomer was added thereto and the addition reaction was performed at 60 to 80° C. in the presence of zinc octylate employed as a reaction catalyst to give a hydroxyethyl acrylate solution of polyether urethane acrylate having an acryl group at a terminal thereof. To 100 g of this solution of urethane acrylate, 2 g of 1-phenyl-2-hydroxy-2-methylpropan-1-one (product name: Darocur 1173, manufactured by Merck & Co. Inc.) as a photosensitizer and 5 g of fine silica powder (product name: Aerosil 200, manufactured by Nippon Aerosil K. K.) were added to thereby give a ultraviolet-curing composition for a flange gasket of a hard disk drive housing case.

### EXAMPLE 2

A polyester urethane acrylate was obtained in the same manner as in Example 1, except for using 100 g of a hydroxy group-containing polyester (product name: F15-20, manufactured by Asahi Denka Kogyo K. K.) and triethylenediamine in place of the polyether and zinc octylate used in Example 1, respectively. To this polyester urethane acrylate were added a photosensitizer (product name: Darocur 1173, manufactured by Merck & Co. Inc.) and 1 g of t-butylperoxyisopropyl carbonate to thereby give an ultraviolet-curing composition having anaerobically curing properties imparted thereto for fixing a cap seal in a hard disk spindle motor.

### Embodiment in Hard Disks

The ultraviolet-curing composition for a gasket obtained in Example 1 was applied onto one face of a flange of a hard disk drive housing case and then irradiated with UV light (2000 mJ) to give a hard disk case having a gasket made of the cured urethane acrylate formed on the flange thereof. Next, a cap seal of a spindle motor and a magnetic head of a hard disk drive were fixed by UV-irradiating and heating (70° C., 20 minutes) the ultraviolet-curing composition for fixing a cap seal obtained in Example 2. Then, a hard disk drive was assembled by fixing with the ultraviolet-curing composition. The obtained hard disk was integrated into a computer and used for 6 months. During this period, the hard disk drive was completely free from operation errors. Then, this hard disk was taken apart and the surface thereof was microscopically observed to examine whether any deposit had been formed thereon or not. As a result, any deposit even in a trace amount (e.g., cloudiness, etc.) could not be found on the disk.

### Function

In the ultraviolet-curing compositions of the invention, no organotin compound is employed as a catalyst in the process for producing urethane acrylate serving as the main component. As a result, no tin compound is contained in the outgas components thereof. Thus, no tin compound adheres to the surface of a disk and there arises neither a collision of a deposit on the disk with the magnetic head nor a chemical reaction with metals deposited on the disk. Thus, operation errors of the hard disk drive can be prevented.

### Effects of the Invention

Because of containing no outgas component, the ultraviolet-curing compositions of the invention which are free from tin compounds are usable in fixing or bonding the following parts of hard disk drives:

(1) packings in housing cases of hard disk drives;

(2) cap seals of spindle motors;

(3) in fixing magnetic heads; and

(4) in bonding substrates to connectors.

Particularly, in the cases of having packing parts made of the ultraviolet-curing compositions of the invention, thermal strain or deformation in the heating steps is not caused, which makes it possible to prevent operation errors caused by dimensional errors.

1. An ultraviolet-curing composition for assembling a hard disk drive, which is used in assembling parts of the hard disk drive, said ultraviolet-curing composition comprising a curable component,
wherein said curable component of said ultraviolet-curing composition is a urethane (meth)acrylate obtained by an addition reaction, using an organic zinc or an amine compound as a catalyst, between:
an isocyanate group of an isocyanate oligomer, which is prepared by using an organic zinc or an amine compound as a catalyst in an addition reaction between an isocyanate group and an active hydrogen; and
a hydroxy group of a hydroxyalkyl (meth)acrylate.

2. The ultraviolet-curing composition for assembling a hard disk drive according to claim 1,
wherein said urethane (meth)acrylate is a product of an addition reaction, using an organic zinc or an amine compound as a catalyst, between:
an isocyanate group of an isocyanate oligomer, which is prepared, by using an organic zinc or an amine compound, from a polyether having a hydroxy group at a terminal thereof and an isocyanate compound having two or more isocyanate groups per molecule; and
a hydroxy group of a hydroxyalkyl (meth)acrylate,
wherein no tin compound is used as a catalyst in these two addition reactions.

3. The ultraviolet-curing composition for assembling a hard disk drive according to claim 1,
wherein the polyurethane (meth)acrylate, which is a main component of said ultraviolet-curing composition, is a product of an addition reaction, using an organic zinc or an amine compound as a catalyst, between:
an isocyanate group of an isocyanate oligomer, which is prepared, by using an organic zinc or an amine compound, from a polyester having a hydroxy group at a terminal or in a side chain thereof and an isocyanate compound having two or more isocyanate groups per molecule; and
a hydroxy group of a hydroxyalkyl (meth)acrylate,
wherein no tin compound is used as a catalyst in these two addition reactions.

4. The ultraviolet-curing composition for assembling a hard disk drive according to claim 1,
wherein the polyurethane (meth)acrylate, which is a main component of said ultraviolet-curing composition, is a product of an addition reaction, using an organic zinc or an amine compound as a catalyst, between:
an isocyanate group of a polyether/polyester copolymerized isocyanate oligomer compound, which is prepared by an addition reaction among a polyester having a hydroxy group at a terminal or in a side chain thereof, a polyether having a hydroxy group at a terminal thereof, and a diisocyanate compound having two or more isocyanate groups per molecule; and
a hydroxy group of a hydroxyalkyl (meth)acrylate,
wherein no tin compound is used as a catalyst in these two addition reactions.
